(19) United States
(12) Patent Application Publication
(10) Pub. No.: US 2019/0292365 A1
(43) Pub. Date: Sep. 26, 2019

(54) POLYMER COMPOSITIONS CONTAINING SILOXANE-ORGANO-COPOLYMERS

(71) Applicant: Wacker Chemie AG, Munich (DE)

(72) Inventor: Oliver SCHAEFER, Burghausen (DE)

(73) Assignee: Wacker Chemie AG, Munich (DE)

(21) Appl. No.: 16/317,707

(22) PCT Filed: Jul. 13, 2016
(86) PCT No.: PCT/EP2016/066629

§ 371 Date: Jan. 14, 2019

(51) Int. Cl. C08L 75/04; C08L 83/10; C08G 77/458; C08J 3/00

(52) U.S. Cl. CPC C08L 75/04; C08J 3/005; C08G 77/458; C08L 83/10

(57) ABSTRACT

Hardness of TPU can be significantly lowered while improving moisture resistance and other physical properties, by incorporating a thermoplastic organopolysiloxane/organic copolymer into the TPU.

### CROSS REFERENCE TO RELATED APPLICATIONS

This application is the U.S. National Phase of PCT Appln. No. PCT/EP2016/066629 filed Jul. 13, 2016, the disclosure of which is incorporated in its entirety by reference herein.

### BACKGROUND OF THE INVENTION

### 1. Field of the Invention

The invention relates to polymer compositions comprising siloxane-organic copolymers and also to organic polymers, methods for producing them, and their use.

### 2. Description of the Related Art

Silicones possess excellent temperature, UV, and weathering stability. They retain their elastic qualities at relatively low temperatures and hence also have no tendency toward embrittlement. In addition, they possess specific water repellency and nonstick surface properties. Furthermore, silicones can be used to produce very flexible elastomers, whose uses include, frequently, medical applications.

Thermoplastic polyurethanes, in contrast, exhibit in some cases excellent adhesion to a variety of surfaces and excellent mechanical properties such as tensile strengths and elongations at break. A disadvantage of thermoplastic polyurethanes (TPUs), however, is the fact that producing relatively flexible types is technically difficult, because the resulting products rapidly become very sticky at low Shore A hardness.

There have been attempts to improve these two classes of material by simple blending. Mention may be made in this context of DE 102008006004 B3, in which high molecular mass silicone polymers were incorporated via masterbatches in small amounts into TPUs, thereby improving the abrasion resistance of the TPUs. Any other influence on the mechanical properties was not reported there. Furthermore, DE 60222454 T2 describes the mixing of covalently crosslinked silicone rubbers into TPUs as so-called thermoplastic silicone vulcanizates. By this process, a crosslinkable silicone mixture is distributed by means of a dynamic vulcanizing process in a TPU melt and at the same time vulcanized. One of the effects of this is to reduce the Shore A hardness of the parent TPU material. Disadvantages of this method include the reductions, in some cases severe, in the tensile strength of the compounded formulation, and also the necessity of requiring, for this method, a specially equipped reactor which simultaneously allows control over the distribution of the silicone component and at the same time ensures the sufficient chemical crosslinking of the silicone mixture.

By introduction of functional groups into the main silicone chain as described in EP 0250248 B1, for example, materials are obtained which likewise have thermoplastic qualities. The thermoplastic silicones which can be produced in this way possess outstanding hydrophobic properties, low Shore A hardnesses, and excellent elongations at break, and also an unusually high transparency. Certain properties of the materials described in EP 0250248 B1, though, such as compression set and adhesion toward other materials, for example, are still not always sufficient.

Both U.S. Pat. No. 6,846,893 and Wynne et. al., Polym. Adv. Technol. 6 (1), pp. 789-790 (1995) describe the mixing of such materials with polyurethanes.

Here it has been found, however, that the mechanical properties of the polymer mixture shown in U.S. Pat. No. 6,846,893 are severely impaired by the incorporation of the thermoplastic siloxane. The presence of the thermoplastic siloxane has an adverse effect here on the mechanical values. Another adverse effect in the examples described is the fact that, here, exclusively oligomeric, reactive siloxane block copolymers are mixed with polyurethanes, which likewise implies a greatly increased cost and complexity of apparatus at the production stage, and also leads to problems with regard to the miscibility of the two materials, since the TPU component is a high molecular mass polymer with a correspondingly high melt viscosity, whereas the siloxane component is an oligomer with a correspondingly low melt viscosity. Controlling the polymer morphology of the desired polymer mixture is therefore difficult to ensure. The mixtures described by Wynne et al. were each as a THF solution; given the different solubilities of the respective polymers in the solvents used, this can lead to irregular mixing of the polymers. One of the manifestations of this is that as the siloxane fraction goes up, the hardness of the parent polyurethane first increases and then decreases again. At all concentrations selected, the addition of the siloxane to the polyurethane results in a decrease in the tensile strength.

In the cases described, therefore, it was not possible, by producing simple polymer blends, to achieve sufficient compability of the different polymer phases and/or the promised improvement in the profile of properties did not materialize.

### SUMMARY OF THE INVENTION

The invention is directed to polymer compositions comprising

(A) at least one polyurethane polymer and
(B) at least one siloxane-organic copolymer having 100 to 3000 siloxane units per siloxane segment and at least one organic segment having at least one group selected from ester groups, amide groups, urethane groups, urea groups, and thiourea groups.

### DETAILED DESCRIPTION OF THE PREFERRED EMBODIMENTS

The organic segments in the copolymers (B) are preferably segments comprising urea, urethane or amide groups; more preferably, the organic segments in the copolymers (B) are segments comprising urea groups or urethane groups.

The distribution of the siloxane segments and the organic segments in the copolymers (B) used in accordance with the invention may be random, e.g., statistical. Component (B) preferably comprises block or comb polymers, more preferably block copolymers.

Component (B) preferably comprises siloxane-organic copolymers of the general formula (1)

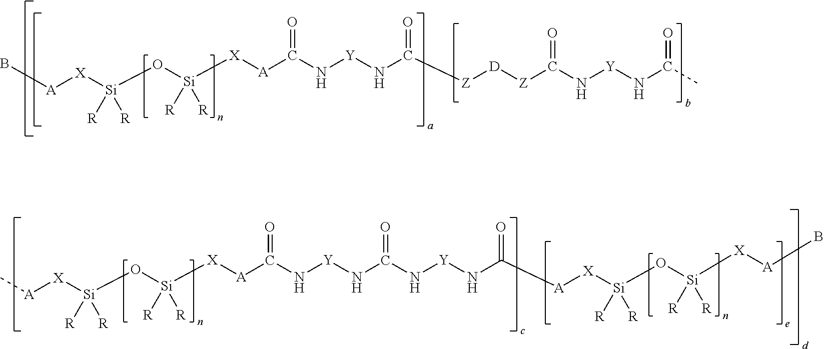

where
R may each be identical or different and is a monovalent, SiC-bonded hydrocarbyl radical having 1 to 20 carbon atoms and optionally substituted by fluorine or chlorine,
X may each be identical or different and is an alkylene radical which has 1 to 20 carbon atoms and in which methylene units not adjacent to one another may have been replaced by —O— groups,
A may each be identical or different and is oxygen, sulfur, or an amino group —NR′—,
Z may each be identical or different and is an oxygen atom or an amino group —NR′—,
R′ may each be identical or different and is hydrogen or an alkyl radical having 1 to 10 carbon atoms,
Y may each be identical or different and is a divalent hydrocarbyl radical which has 1 to 20 carbon atoms and is optionally substituted by fluorine or chlorine,
D may each be identical or different and is a divalent hydrocarbyl radical which is optionally substituted by fluorine, chlorine or C₁-C₆ alkyl ester groups and in which methylene units not adjacent to one another may have been replaced by —O—, —COO—, —OCO— or —OCOO— groups,
B may each be identical or different and is hydrogen or a functional or nonfunctional organic or silicon-organic radical,
n may each be identical or different and is a number from 99 to 2999,
a is a number which is at least 1,
b is 0 or a number from 1 to 100,
c is 0 or a number from 1 to 100,
d is a number which is at least 1, and
e is a number which is 0 or 1.

The weight ratio of the siloxane-organic copolymer (B) to the polyurethane polymer (A) is preferably in the range from 10:90 to 80:20, more preferably 20:80 to 60:40, most preferably 20:80 to 50:50.

The polymer compositions of the invention are preferably thermoplastic are preferably reprocessable.

Examples of R are alkyl radicals such as the methyl, ethyl, n-propyl, isopropyl, 1-n-butyl, 2-n-butyl, isobutyl, tert-butyl, n-pentyl, isopentyl, neopentyl, and tert-pentyl radicals; hexyl radicals such as the n-hexyl radical; heptyl radicals such as the n-heptyl radical; octyl radicals such as the n-octyl radical and isooctyl radicals such as the 2,2,4-trimethylpentyl radical; nonyl radicals such as the n-nonyl radical; decyl radicals such as the n-decyl radical; dodecyl radicals such as the n-dodecyl radical; octadecyl radicals such as the n-octadecyl radical; cycloalkyl radicals such as the cyclopentyl, cyclohexyl, cycloheptyl and methylcyclohexyl radicals; alkenyl radicals such as the vinyl, 1-propenyl, and 2-propenyl radicals; aryl radicals such as the phenyl, naphthyl, anthryl, and phenanthryl radicals; alkaryl radicals such as o-, m-, p-tolyl radicals, xylyl radicals, and ethylphenyl radicals; or aralkyl radicals such as the benzyl radical or the α- and the β-phenylethyl radicals.

Examples of halogenated radicals R are haloalkyl radicals such as the 3,3,3-trifluoro-n-propyl radical, the 2,2,2,2′,2′,2′-hexafluoroisopropyl radical and the heptafluoroisopropyl radical.

Radical R is preferably a monovalent hydrocarbyl radical which has 1 to 20 carbon atoms and is optionally substituted by fluorine and/or chlorine atoms, more preferably is a hydrocarbyl radical which has 1 to 6 carbon atoms, and most preferably is a methyl, ethyl, vinyl or phenyl radical.

Examples of radical X are the alkylene radicals indicated below for radical Y. Radical X preferably comprises an alkylene radical having 1 to 10 carbon atoms, more preferably the methylene or n-propylene radical.

A is preferably a radical —NR′— where R′ matches the definition stated above, more preferably an —NH— radical.

Radical R′ is preferably hydrogen.

Radical Z preferably has the definition of —O— or —NH—.

Examples of radical Y are alkylene radicals such as the methylene, ethylene, n-propylene, isopropylene, n-butylene, isobutylene, tert-butylene, n-pentylene, isopentylene, neopentylene, and tert-pentylene radicals, hexylene radicals, heptylene radicals, octylene radicals, nonylene radicals, decylene radicals, dodecylene radicals or octadecylene radicals; cycloalkylene radicals such as the cyclopentylene radical, the 1,4-cyclohexylene radical, the isophoronylene radical or the 4,4′-methylenedicyclohexylene radical; alkenylene radicals such as the vinylene, n-hexenylene, cyclohexenylene, 1-propenylene, allylene, butenylene or 4-pentenylene radicals; alkynylene radicals such as the ethynylene or propargylene radicals; arylene radicals such as the phenylene, bisphenylene, naphthylene, anthrylene or phenanthrylene radicals; alkarylene radicals such as o-, m-, p-tolylene radicals, xylylene radicals or ethylphenylene radicals; or aralkylene radicals such as the benzylene radical, the 4,4′-methylenediphenylene radical, the α- or the β-phenylethylene radicals.

Radical Y preferably comprises a hydrocarbyl radical having 3 to 13 carbon atoms, more preferably linear or cyclic alkylene radicals.

Examples of radicals D are the examples indicated for Y, and also polyoxyalkylene radicals, such as polyoxyethylene radicals or polyoxypropylene radicals.

D is preferably a divalent hydrocarbyl radical which has 1 to 700 carbon atoms and is optionally substituted by fluorine atoms, chlorine atoms or C₁-C₆ alkyl ester groups, or is a polyoxyalkylene radical. Where D is optionally substituted hydrocarbyl radical, it preferably comprises alkylene radicals having 2 to 12 carbon atoms, more particularly having 4 to 12 carbon atoms. Where D is a polyoxyalkylene radical, it preferably comprises those having 20 to 800 carbon atoms, more preferably 20 to 200 carbon atoms, yet more preferably 20 to 100 carbon atoms, and most preferably comprises polyoxyethylene radicals or polyoxypropylene radicals.

Index n is preferably a number from 99 to 800, more preferably from 120 to 300, most preferably from 120 to 200.

Preferably, a is a number from 1 to 1000, more preferably from 3 to 250, most preferably from 5 to 100.

If b is not 0, b is preferably a number from 1 to 250, more preferably 1 to 30. Preferably, b is less than or equal to the sum of a+c+e, and with particular preference b is 0.

Index c is preferably 0 or a number from 1 to 10, more preferably 0 or a number from 1 to 5.

Preferably d is a number from 1 to 30, more preferably from 1 to 20, most preferably from 1 to 10.

The organopolysiloxane/polyurea/polyurethane block copolymers are already known and are preferably produced by methods in accordance with the prior art, as described in EP-A 250248, EP-A 822951 or DE-A 10137855, for example, more preferably as described in DE-A 10137855.

Possible end groups B in formula (1) are customary end groups according to the prior art that come about as standard during the synthesis of such polymers—examples are hydrogen or isocyanate end groups. These end groups may also be reacted with further groups during the polymer synthesis or subsequently, such as with aliphatic amines, alcohols or amino- or isocyanato-silanes, for example. It is possible, moreover, during the synthesis itself to add monofunctional organic compounds which are reactive toward isocyanate groups, such as primary or secondary alcohols or amines, it being possible thereby in an elegant manner additionally to control the rheological properties and the molecular weight of the siloxane-organic copolymers (B).

Preferred examples of end groups B besides hydrogen atom are structures of the general formulae

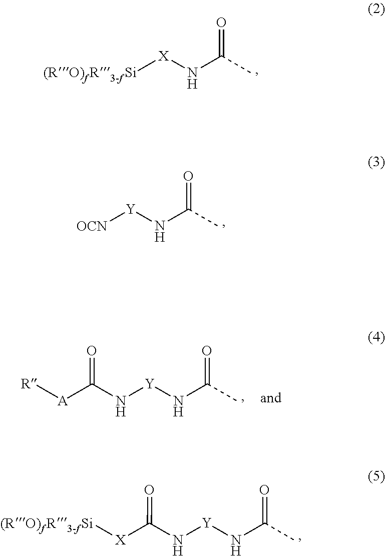

where
X may each be identical or different and is an alkylene radical which has 1 to 20 carbon atoms and in which methylene units not adjacent to one another may have been replaced by —O— groups,
A may each be identical or different and is oxygen, sulfur, or an amino group —NR′—,
R′ may each be identical or different and is hydrogen or an alkyl radical having 1 to 10 carbon atoms,
R″ may each be identical or different and is hydrogen or an alkyl radical having 1 to 20 carbon atoms,
Y may each be identical or different and is a divalent hydrocarbyl radical which has 1 to 20 carbon atoms and is optionally substituted by fluorine or chlorine,
R′″ may each be identical or different and is an alkyl radical having 1 to 20 carbon atoms, and
f is 0, 1, 2 or 3.

Examples of radical R″ are hydrogen and also the examples indicated above for radical R.

Radical R″ preferably comprises an alkyl radical having 3 to 12 carbon atoms.

Examples of radical R′″ are the examples indicated above for radical R. Preferably radical R′″ is an alkyl radical having 1 to 4 carbon atoms, more preferably the methyl or ethyl radical.

The end groups B are more preferably urea groups of the general formula (4) or end groups of the general formulae (2) or (5).

In the case of the component (B) used in accordance with the invention, the amount of siloxane units is preferably between 80 and 99.5 wt %, more preferably between 90 and 99 wt %, most preferably between 95 and 99 wt %.

Examples of siloxane-organic copolymers (B) are

(C₂H₅O)₃—Si—C₃H₆—NH—CO—[NH—(CH₂)₃—Si(CH₃)₂—(O—Si(CH₃)₂)₁₃₀₋₁₆₀—(CH₂)₃—NH—CO—NH-p-C₆H₁₀—CH₂-p-C₆H₁₀—NH—CO]₁₅₋₂₅—NH(CH₂)₃SiMe₂(OSiMe₂)₁₃₀₋₁₆₀(CH₂)₃—NH—CO—NH—C₃H₆—Si(OC₂H₅)₃,
(H₃CO)₃—Si—C₃H₆—NH—CO—[NH—(CH₂)₃—Si(CH₃)₂—(O—Si(CH₃)₂)₁₃₀₋₁₆₀—(CH₂)₃—NH—CO—NH-p-C₆H₁₀—CH₂-p-C₆H₁₀—NH—CO]₁₅₋₂₅—NH(CH₂)₃SiMe₂(OSiMe₂)₁₃₀₋₁₆₀(CH₂)₃—NH—CO—NH—C₃H₆—Si(OCH₃)₃,
(C₂H₅O)₃—Si—CH₂—NH—CO—[NH—(CH₂)₃—Si(CH₃)₂—(O—Si(CH₃)₂)₁₃₀₋₁₆₀—(CH₂)₃—NH—CO—NH-p-C₆H₁₀—CH₂-p-C₆H₁₀—NH—CO]₁₅₋₂₅—NH(CH₂)₃SiMe₂(OSiMe₂)₁₃₀₋₁₆₀-(CH₂)₃—NH—CO—NH—CH₂—Si(OC₂H₅)₃,
(H₅C₂O)₃—Si—C₃H₆—NH—CO—NH-p-C₆H₁₀—CH₂-p-C₆H₁₀—NH—CO—[NH—(CH₂)₃—Si(CH₃)₂—(O—Si(CH₃)₂)₁₃₀₋₁₆₀—(CH₂)₃—NH—CO—NH-p-C₆H₁₀—CH₂-p-C₆H₁₀—NH—CO]₁₅₋₂₅—[NH—(CH₂)₃—Si(CH₃)₂—(O—Si(CH₃)₂)₁₃₀₋₁₆₀—(CH₂)₃—NH—CO—NH-p-C₆H₁₀—CH₂-p-C₆H₁₀—NH]—CO—NH—C₃H₆—Si(OC₂H₅)₃,
(H₅C₂O)₃—Si—CH₂—NH—CO—NH-p-C₆H₁₀—CH₂-p-C₆H₁₀—NH—CO—[NH—(CH₂)₃—Si(CH₃)₂—(O—Si(CH₃)₂)₁₃₀₋₁₆₀—(CH₂)₃—NH—CO—NH-p-C₆H₁₀—CH₂-p-C₆H₁₀—NH—CO]₁₅₋₂₅—[NH—(CH₂)₃—Si(CH₃)₂—(O—Si(CH₃)₂)₁₃₀₋₁₆₀—(CH₂)₃—NH—CO—NH-p-C₆H₁₀—CH₂-p-C₆H₁₀—NH]—CO—NH—CH₂—Si(OC₂H₅)₃,
(H₃CO)₃—Si—C₃H₆—NH—CO—NH-p-C₆H₁₀—CH₂-p-C₆H₁₀—NH—CO—[NH—(CH₂)₃—Si(CH₃)₂—(O—Si(CH₃)₂)₁₃₀₋₁₆₀—(CH₂)₃—NH—CO—NH-p-C₆H₁₀—CH₂-p-C₆H₁₀—NH—CO]₁₅₋₂₅—[NH—(CH₂)₃—Si(CH₃)₂—(O—Si(CH₃)₂)₁₃₀₋₁₆₀—(CH₂)₃—NH—CO—NH-p-C₆H₁₀—CH₂-p-C₆H₁₀—NH]—CO—NH—C₃H₆—Si(OCH₃)₃,
H₃C(H₃CO)₂—Si—C₃H₆—NH—CO—NH-p-C₆H₁₀—CH₂-p-C₆H₁₀—NH—CO—[NH—(CH₂)₃—Si(CH₃)₂—(O—Si(CH₃)₂)₁₃₀₋₁₆₀—(CH₂)₃—NH—CO—NH-p-C₆H₁₀—CH₂-p-C₆H₁₀—NH—CO]₁₅₋₂₅—[NH—(CH₂)₃—Si(CH₃)₂—(O—Si(CH₃)₂)₁₃₀₋₁₆₀—(CH₂)₃—NH—CO—NH-p-C₆H₁₀—CH₂-p-C₆H₁₀—NH]—CO—NH—C₃H₆—Si(OCH₃)₂CH₃,
n-C₄H₉—NH—CO—NH-p-C₆H₁₀—CH₂-p-C₆H₁₀—NH—CO— [NH—(CH₂)₃—Si(CH₃)₂—(O—Si(CH₃)₂)₁₃₀₋₁₆₀—(CH₂)₃—NH—CO—NH-p-C₆H₁₀—CH₂-p-C₆H₁₀—NH—CO]₁₅₋₂₅—[NH—(CH₂)₃—Si(CH₃)₂—(O—Si(CH₃)₂)₁₃₀₋₁₆₀—(CH₂)₃—NH—CO—NH-p-C₆H₁₀—CH₂-p-C₆H₁₀—NCO,
n-C₄H₉—NH—CO—NH-p-C₆H₁₀—CH₂-p-C₆H₁₀—NH—CO—[NH—(CH₂)₃—Si(CH₃)₂—(O—Si(CH₃)₂)₁₃₀₋₁₆₀—(CH₂)₃—NH—CO—NH-p-C₆H₁₀—CH₂-p-C₆H₁₀—NH—CO]₁₅₋₂₅—[NH—(CH₂)₃—Si(CH₃)₂—(O—Si(CH₃)₂)₁₃₀₋₁₆₀—(CH₂)₃—NH—CO—NH-p-C₆H₁₀—CH₂-p-C₆H₁₀—NH—CO—NH-n-C₄H₉
(C₂H₅O)₃—Si—C₃H₆—NH—CO—[NH—(CH₂)₃—Si(CH₃)₂—(O—Si(CH₃)₂)₁₃₀₋₁₆₀—(CH₂)₃—NH—CO—NH—C₁₀H₁₈—NH—CO]₂₅₋₃₅—NH(CH₂)₃SiMe₂(OSiMe₂)₁₃₀₋₁₆₀(CH₂)₃—NH—CO—NH—C₃H₆—Si(OC₂H₅)₃,
(C₂H₅O)₃—Si—CH₂—NH—CO—[NH—(CH₂)₃—Si(CH₃)₂—(O—Si(CH₃)₂)₁₃₀₋₁₆₀—(CH₂)₃—NH—CO—NH—C₁₀H₁₈—NH—CO]₂₅₋₃₅—NH(CH₂)₃SiMe₂(OSiMe₂)₁₃₀₋₁₆₀(CH₂)₃—NH—CO—NH—CH₂—Si(OC₂H₅)₃,
(H₃CO)₃—Si—C₃H₆—NH—CO—[NH—(CH₂)₃—Si(CH₃)₂—(O—Si(CH₃)₂)₁₃₀₋₁₆₀—(CH₂)₃—NH—CO—NH—C₁₀H₁₈—NH—CO]₂₅₋₃₅—NH(CH₂)₃SiMe₂(OSiMe₂)₁₃₀₋₁₆₀(CH₂)₃—NH—CO—NH—C₃H₆—Si(OCH₃)₃,
(H₃CO)₃—Si—C₃H₆—NH—CO—[NH—(CH₂)₃—Si(CH₃)₂—(O—Si(CH₃)₂)₁₃₀₋₁₆₀—(CH₂)₃—NH—CO—NH—C₁₀H₁₈—NH—CO]₁₀₋₁₅—[NH—C₆H₁₂—NH—CO—NH—C₁₀H₁₈—NH—CO]₅—NH(CH₂)₃SiMe₂(OSiMe₂)₁₃₀₋₁₆₀—(CH₂)₃—NH—CO—NH—C₃H₆—Si(OCH₃)₃,
(H₃CO)₃—Si—C₃H₆—NH—CO—NH—C₁₀H₁₈—NH—CO—[NH—(CH₂)₃—Si(CH₃)₂—(O—Si(CH₃)₂)₁₃₀₋₁₆₀—(CH₂)₃—NH—CO—NH—C₁₀H₁₈—NH—CO]₁₀₋₁₅ [NH—(CH₂)₃—Si(CH₃)₂—(O—Si(CH₃)₂)₁₃₀₋₁₆₀—(CH₂)₃—NH—CO—NH—C₁₀H₁₈—NH]—CO—NH—C₃H₆—Si(OCH₃)₃,
H₃C(H₃CO)₂—Si—C₃H₆—NH—CO—NH—C₁₀H₁₈—NH—CO—[NH—(CH₂)₃—Si(CH₃)₂—(O—Si(CH₃)₂)₁₃₀₋₁₆₀—(CH₂)₃—NH—CO—NH—C₁₀H₁₈—NH—CO]₂₅₋₃₅—NH—(CH₂)₃—Si(CH₃)₂—(O—Si(CH₃)₂)₁₃₀₋₁₆₀—(CH₂)₃—NH—CO—NH—C₁₀₁₋₁₁₈—NH—CO—NH—C₃H₆—Si(OCH₃)₂CH₃,
(H₅C₂O)₃—Si—C₃H₆—NH—CO—NH—C₁₀H₁₈—NH—CO—[NH—(CH₂)₃—Si(CH₃)₂—(O—Si(CH₃)₂)₁₃₀₋₁₆₀—(CH₂)₃—NH—CO—NH—C₁₀H₁₈—NH—CO]₂₅₋₃₅—NH—(CH₂)₃—Si(CH₃)₂—(O—Si(CH₃)₂)₁₃₀₋₆₁₀—(CH₂)₃—NH—CO—NH—C₁₀H₁₈—NH—CO—NH—C₃H₆—Si(OC₂H₅)₃,
(C₂H₅O)₃—Si—C₃H₆—NH—CO—[NH—(CH₂)₃—Si(CH₃)₂—(O—Si(CH₃)₂)₁₃₀₋₁₆₀—(CH₂)₃—NH—CO—NH—C₆H₁₂—NH—CO]₂₅₋₃₅—NH(CH₂)₃SiMe₂(OSiMe₂)₁₃₀₋₁₆₀(CH₂)₃—NH—CO—NH—C₃H₆—Si(OC₂H₅)₃,
(C₂H₅O)₃—Si—CH₂—NH—CO—[NH—(CH₂)₃—Si(CH₃)₂—(O—Si(CH₃)₂)₁₃₀₋₁₆₀—(CH₂)₃—NH—CO—NH—C₆H₁₂—NH—CO]₂₅₋₃₅—NH(CH₂)₃SiMe₂(OSiMe₂)₁₃₀₋₁₆₀(CH₂)₃—NH—CO—NH—CH₂—Si(OC₂H₅)₃,
(H₃CO)₃—Si—C₃H₆—NH—CO—[NH—(CH₂)₃—Si(CH₃)₂—(O—Si(CH₃)₂)₁₃₀₋₁₆₀—(CH₂)₃—NH—CO—NH—C₆H₁₂—NH—CO]₂₅₋₃₅—NH(CH₂)₃SiMe₂(OSiMe₂)₁₃₀₋₁₆₀(CH₂)₃—NH—CO—NH—C₃H₆—Si(OCH₃)₃,
(H₃CO)₃—Si—C₃H₆—NH—CO—NH—C₆H₁₂—NH—CO—[NH—(CH₂)₃—Si(CH₃)₂—(O—Si(CH₃)₂)₁₃₀₋₁₆₀—(CH₂)₃—NH—CO—NH—C₆H₁₂—NH—CO]₂₅₋₃₅—NH—(CH₂)₃—Si(CH₃)₂—(O—Si(CH₃)₂)₁₃₀₋₁₆₀—(CH₂)₃—NH—CO—NH—C₆H₁₂—NH—CO—NH—C₃H₆—Si(OCH₃)₃,
H₃C(H₃CO)₂—Si—C₃H₆—NH—CO—NH—C₆H₁₂—NH—CO—[NH—(CH₂)₃—Si(CH₃)₂—(O—Si(CH₃)₂)₁₃₀₋₁₆₀—(CH₂)₃—NH—CO—NH—C₆H₁₂—NH—CO]₂₅₋₃₅—NH—(CH₂)₃—Si(CH₃)₂—(O—Si(CH₃)₂)₁₃₀₋₁₆₀—(CH₂)₃—NH—CO—NH—C₆H₁₂—NH—CO—NH—C₃H₆—Si(OCH₃)₂CH₃,
(H₅C₂O)₃—Si—C₃H₆—NH—CO—NH—C₆H₁₂—NH—CO—[NH—(CH₂)₃—Si(CH₃)₂—(O—Si(CH₃)₂)₁₃₀₋₁₆₀—(CH₂)₃—NH—CO—NH—C₆H₁₂—NH—CO]₂₅₋₃₅—NH—(CH₂)₃—Si(CH₃)₂—(O—Si(CH₃)₂)₁₃₀₋₁₆₀—(CH₂)₃—NH—CO—NH—C₆H₁₂—NH—CO—NH—C₃H₆—Si(OC₂H₅)₃,
(C₂H₅O)₃—Si—C₃H₆—NH—CO—[NH—(CH₂)₃—Si(CH₃)₂—(O—Si(CH₃)₂)₁₈₀₋₂₂₀—(CH₂)₃—NH—CO—NH-p-C₆H₁₀—CH₂-p-C₆H₁₀—NH—CO]₁₀₋₂₀—NH(CH₂)₃SiMe₂(OSiMe₂)₁₈₀₋₂₂₀—CH₂)₃—NH—CO—NH—C₃H₆—Si(OC₂H₅)₃,
(C₂H₅O)₃—Si—CH₂—NH—CO— [NH—(CH₂)₃—Si(CH₃)₂—(O—Si(CH₃)₂)₁₈₀₋₂₂₀—(CH₂)₃—NH—CO—NH-p-C₆H₁₀—CH₂-p-C₆H₁₀—NH—CO]₈₋₂₀—NH(CH₂)₃SiMe₂(OSiMe₂)₁₈₀₋₂₂₀ (CH₂)₃—NH—CO—NH—CH₂—Si(OC₂H₅)₃,
(C₂H₅O)₃—Si—C₃H₆—NH—CO—[NH—(CH₂)₃—Si(CH₃)₂—(O—Si(CH₃)₂)₁₈₀₋₂₂₀—(CH₂)₃—NH—CO—NH-p-C₆H₁₀—CH₂-p-C₆H₁₀—NH—CO]₈₋₂₀—[NH—CH₂—CH₂—NH—CO—NH-p-C₆H₁₀—CH₂-p-C₆H₁₀—NH—CO]₃₋₈—NH(CH₂)₃SiMe₂(OSiMe₂)₁₈₀₋₂₂₀(CH₂)₃—NH—CO—NH—C₃H₆—Si(OC₂H₅)₃,
(C₂H₅O)₃—Si—CH₂—NH—CO—[NH—(CH₂)₃—Si(CH₃)₂—(O—Si(CH₃)₂)₁₈₀₋₂₂₀—(CH₂)₃—NH—CO—NH-p-C₆H₁₀—CH₂-p-C₆H₁₀—NH—CO]₈₋₂₀—[NH—CH₂—CH₂—NH—CO—NH-p-C₆H₁₀—CH₂-p-C₆H₁₀—NH—CO]₃₋₈—NH(CH₂)₃SiMe₂(OSiMe₂)₁₈₀₋₂₂₀(CH₂)₃—NH—CO—NH—CH₂—Si(OC₂H₅)₃,
n-C₄H₉—NH—CO—NH-p-C₆H₁₀—CH₂-p-C₆H₁₀—NH—CO—[NH—(CH₂)₃—Si(CH₃)₂—(O—Si(CH₃)₂)₁₈₀₋₂₂₀—(CH₂)₃—NH—CO—NH-p-C₆H₁₀—CH₂-p-C₆H₁₈—NH—CO]₈₋₂₀—NH-n-C₄H₉,
n-C₄H₉—NH—CO—NH—C₁₀H₁₈—NH—CO—[NH—(CH₂)₃—Si(CH₃)₂—(O—Si(CH₃)₂)₁₈₀₋₂₂₀—(CH₂)₃—NH— CO—NH—C₁₀H₁₈—NH—CO]₈₋₂₀—NH-n-C₄H₉,
n-C₄H₉—NH—CO—NH—C₆H₁₂—NH—CO—[NH—(CH₂)₃—Si(CH₃)₂—(O—Si(CH₃)₂)₁₈₀₋₂₂₀—(CH₂)₃—NH—CO—NH—C₆H₁₂—NH—CO]₈₋₂₀—NH-n-C₄H₉,
n-C₄H₉—NH—CO—NH-p-C₆H₁₀—CH₂-p-C₆H₁₀—NH—CO—[NH—(CH₂)₃—Si(CH₃)₂—(O—Si(CH₃)₂)₁₈₀₋₂₂₀—(CH₂)₃—NH—CO—NH-p-C₆H₁₀—CH₂-p-C₆H₁₈—NH—CO]₈₋₂₀—[NH—(CH₂)₃—Si(CH₃)₂—(O—Si(CH₃)₂)₁₈₀₋₂₂₀—(CH₂)₃—NH—CO—NH—C₁₀H₁₈—NH—CO]₄₋₁₀NH-n-C₄H₉,
n-C₄H₉—NH—CO—NH-p-C₆H₁₀—CH₂-p-C₆H₁₀—NH—CO—[NH—(CH₂)₃—Si(CH₃)₂—(O—Si(CH₃)₂)₁₈₀₋₂₂₀—(CH₂)₃—NH—CO—NH-p-C₆H₁₀—CH₂-p-C₆H₁₀—NH—CO]₈₋₂₀—NH—(CH₂)₃—Si(CH₃)₂—(O—Si(CH₃)₂)₁₈₀₋₂₂₀—(CH₂)₃—NH₂,
n-C₄H₉—NH—CO—NH—C₁₀H₁₈—NH—CO—[NH—(CH₂)₃—Si(CH₃)₂—(O—Si(CH₃)₂)₁₈₀₋₂₂₀—(CH₂)₃—NH—CO—NH—C₁₀H₁₈—NH—CO]₈₋₂₀—NH—(CH₂)₃—Si(CH₃)₂—(O—Si(CH₃)₂)₁₈₀₋₂₂₀—(CH₂)₃—NH₂,
H—[NH—(CH₂)₃—Si(CH₃)₂—(O—Si(CH₃)₂)₁₈₀₋₂₂₀—(CH₂)₃—NH—CO—NH-p-C₆H₁₀—CH₂-p-C₆H₁₀—NH—CO]₈₋₂₀—[NH—(CH₂)₃—Si(CH₃)₂—(O—Si(CH₃)₂)₁₈₀₋₂₂₀—(CH₂)₃—NH₂,
H[NH—(CH₂)₃—Si(CH₃)₂—(O—Si(CH₃)₂)₁₈₀₋₂₂₀—(CH₂)₃—NH—CO—NH—C₆H₁₂—NH—CO]₈₋₂₀—NH—(CH₂)₃—Si(CH₃)₂—(O—Si(CH₃)₂)₁₈₀₋₂₂₀—(CH₂)₃—NH₂, and
n-C₄H₉—NH—CO—NH-p-C₆H₁₀—CH₂-p-C₆H₁₀—NH—CO—[NH—(CH₂)₃—Si(CH₃)₂—(O—Si(CH₃)₂)₁₈₀₋₂₂₀—(CH₂)₃—NH—CO—NH-p-C₆H₁₀—CH₂-p-C₆H₁₀—NH—CO]₈₋₂₀—[NH—(CH₂)₃—Si(CH₃)₂—(O—Si(CH₃)₂)₁₈₀₋₂₂₀—(CH₂)₃—NH—CO—NH—C₁₀H₁₈—NH—CO]₄₋₁₀NH—(CH₂)₃—Si(CH₃)₂—(O—Si(CH₃)₂)₁₈₀₋₂₂₀—(CH₂)₃—NH₂.

Component (B) more particularly comprises copolymers of formula (1) with R=methyl radical, X═—C₃H₆—, A=NH or O, but preferably NH, Z═NH or O, but preferably NH, R′ is preferably hydrogen atom, Y═—C₆H₁₀—CH₂—C₆H₁₀— or —C₁₀H₁₈—, D=—C₂H₄— or —C₆H₁₂—, B═

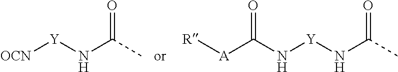

with R″═—C₄H₉ or —C₁₂H₂₅, and n=100 to 300, a=5 to 20, b=0, 1 or 2, c=0 or 1, but preferably 0, d= at least 1, and e=0 or 1.

The copolymers (B) used in accordance with the invention preferably have a Shore A hardness of below 50, more preferably below 40 and most preferably below 30. The copolymers (B) used in accordance with the invention preferably have a Shore A hardness of at least 5.

The Shore A hardness here is determined in accordance with DIN EN 53505.

The average molecular weight Mₙ (number average) of component (B) is preferably at least 50,000 g/mol, more preferably at least 100,000 g/mol. The copolymers (B) used in accordance with the invention have an average molecular weight Mₙ of at most 1,000,000 g/mol.

The number-average molar mass Mn in the context of the present invention is determined by means of size exclusion chromatography (SEC) against polystyrene standard, in THF, at 45° C., flow rate 1.0 ml/min, and detection with ELSD (evaporative light scattering detector) on a triple column set of PLGel MixC columns from Agilent Technologies with an injection volume of 100 μL after acetylation with acetic anhydride.

The siloxane-organic copolymers (B) used in accordance with the invention are preferably solid at 25° C. and 1000 hPa.

The siloxane-organic copolymers (B) used in accordance with the invention have a softening range at 1000 hPa preferably greater than or equal to 50° C., more preferably above 80° C., yet more preferably above 120° C., and most preferably from 140 to 220° C.

For the purposes of this invention, the softening range here is defined as the temperature range (at shear rates of 0.1 l/s to 1000 l/s), in which the loss factor (G″/G′) according to ISO 6721-10 has a value of 1.

For the purposes of the present invention, the term “polymer” encompasses homopolymers, copolymers or terpolymers.

The polyurethane polymers (A) used in accordance with the invention are preferably free from Si atoms.

Polyurethane polymers (A) are preferably thermoplastic, meaning that the products are solid at 25° C. and 1000 hPa and can be deformed reversibly within a certain temperature range above 25° C. at 1000 hPa. These thermoplastic polyurethanes are generally referred to by the skilled person as TPUs.

Thermoplastic polyurethane polymers (TPUs) which can be used as component (A) are known to the skilled person and are obtained customarily by the reaction of a linear, hydroxy-terminated polyol (usually polyester polyols or polyether polyols), an organic diisocyanate, and a chain extender (oftentimes a short-chain diol). Examples of the kinds of linear, hydroxy-terminated polyols, organic diisocyanates, and chain extenders which are useful as reaction components for producing the thermoplastic polyurethane polymers of the present invention are described in, for example, Encyclopedia of Chemical Technology, 3^{rd} edition, volume 23, in “Urethane Polymers”, pages 576-608 (Wiley & Sons, NY), in Encyclopedia of Polymer Science and Engineering, volume 13, in “Polyurethanes”, pages 243-303 (Wiley & Sons, NY), and in the U.S. Pat. Nos. 5,905,133, 5,908,894, and 6,054,533, all of which patents are hereby incorporated by reference.

Methods for producing the thermoplastic polyurethane polymers (A) used in accordance with the invention are well-known. Customarily, the linear, hydroxyl-terminated polyol, the organic diisocyanate, and the chain extender are reacted together with optional catalysts and auxiliary substances and/or additives in amounts so that the equivalents ratio of the NCO groups to the sum of the groups which react with isocyanate, more particularly the OH groups of the low molecular mass diols/triols and polyols, is typically in the range from 0.9:1.0 to 1.1:1.0 or, alternatively thereto, from 0.95:1.0 to 1.10:1.0.

The diols used for producing the polyurethane polymers (A) are preferably diols based on polytetramethylene glycol or polycaprolactone.

Preferred examples of TPUs used as component (A) in accordance with the invention comprise polyester polyadipate-based polyurethane, such as Pellethane® 2355-80 AE (Lubrizol, Wickliffe, Ohio, USA), or polyether- and polyester-based polyurethane, such as Pellethane® 2102 (Lubrizol, Wickliffe, Ohio, USA), Pellethane® 2103 (Lubrizol, Wickliffe, Ohio, USA), Elastollan® C series, Elastollan® 600 series, and Elastollan® S series (BASF SE, Germany).

With particular preference the component (A) used in accordance with the invention comprises polyether-based TPUs.

The polyurethane polymers (A) are preferably colorless.

Polyurethane polymers (A) used in accordance with the invention preferably have a Shore A hardness of at most 90, more preferably below 80, and most preferably at most 70.

Polyurethane polymers (A) preferably have a Shore A hardness of at least 50.

Polyurethane polymers (A) used in accordance with the invention preferably have a tensile strength of greater than 15 MPa, more preferably greater than 20 MPa, and most preferably greater than 25 MPa. Polyurethane polymers (A) have a tensile strength of at most 70 MPa.

The elongation at break of the polyurethane polymers (A) is preferably greater than 300%, more preferably greater than 500%, most preferably greater than 700%, but at most an elongation at break of 1500%.

The polyurethane polymers (A) used in accordance with the invention are preferably solid at 25° C. and 1000 hPa.

The polyurethane polymers (A) used in accordance with the invention preferably have a softening range of 90 to 220° C. at 1000 hPa.

Polyurethane polymers (A) are preferably used in accordance with the invention in pellet form.

In addition to the components (A) and (B), the polymer compositions of the invention may comprise further substances different from the components (A) and (B), such as, for example, nonpolyurethane polymers (A′), organic or inorganic fillers (C), inorganic fibers (D), flame retardants (E), biocides (F), pigments (G), UV absorbers (H), and HALS stabilizers (I).

Optional nonpolyurethane polymers (A′) are preferably thermoplastic, meaning that the products are solid at 25° C. and 1000 hPa and can be deformed reversibly in a defined temperature range above 25° C. at 1000 hPa.

Preferred examples of optional thermoplastic polymers (A′) are polyamides, polyesters, polyacrylates, polyolefins, functional polyolefins, polystyrenes or PVC, with particular preference, polyamides.

If polymers (A′) are used, the amounts are preferably 1 to 40 parts by weight, more preferably 5 to 30 parts by weight, based in each case on 100 parts by weight of component (A). The compositions of the invention preferably contain no polymers (A′).

The optional fillers (C) are preferably inorganic fillers, more preferably quartz, talc, calcium carbonate, kieselguhr or calcium silicate or silicas. Preferred examples of optional inorganic fibers (D) are glass fibers, basalt fibers or wollastonite, preferably glass fibers.

If inorganic fibers (D) are used, the amounts are preferably 1 to 30 wt %, more preferably 5 to 15 wt %. The polymer compositions of the invention preferably contain no component (D).

Preferred examples of optional flame retardants (E) are organic flame retardants based on halogenated organic compounds or inorganic flame retardants, aluminum hydroxide, (ATH) or magnesium hydroxide for example.

If flame retardants (E) are used, preference is given to inorganic flame retardants such as ATH.

Preferred examples of optional biocides (F) are inorganic fungicides, for example borates such as zinc borate, or organic fungicides such as thiabendazole.

Preferred examples of optional pigments (G) are organic pigments or inorganic pigments such as iron oxides or titanium dioxide.

If pigments (G) are used, the amounts are preferably 0.2 to 7 wt %, more preferably 0.5 to 3 wt %. It is preferred for pigments (G) to be used.

Examples of optional UV absorbers (H) are benzophenones, benzotriazoles or triazines.

If UV absorbers (H) are used, benzotriazoles and triazines are preferred.

Preferred examples of optional HALS stabilizers (I) are piperidine or piperidyl derivatives for example, and are available under brand names including Tinuvin (BASF SE, Ludwigshafen (DE)).

To produce the compositions of the invention, preferably no ingredients beyond components (A), (B), optionally (A′) and also optionally (C) to (I) are used. Production of the composition of the invention may be accompanied by formation of reaction products, such as, for example, polydimethylsiloxane-urethane polyethers, polydimethylsiloxane-urea polyethers, polydimethylsiloxane-urethane polyesters or polydimethylsiloxane-urea polyesters, in the reaction of the components (B) with (A) and/or (C).

The individual ingredients of the composition of the invention may in each case comprise one kind of such an ingredient or else a mixture of at least two different kinds of such ingredients.

The polymer compositions of the invention preferably have preferably both thermoplastic and elastomeric qualities.

Hence the elongation at break of the polymer compositions of the invention is preferably at least 200%, more preferably at least 500%. The elongation at break of the polymer compositions of the invention is preferably not more than 2000%.

The tensile strength of the polymer compositions of the invention is preferably at least 2 MPa, more preferably at least 4 MPa, most preferably at least 10 MPa. The tensile strength of the polymer compositions of the invention is preferably not more than 50 MPa.

The Shore A hardness of the polymer compositions of the invention is preferably at most 80, more preferably at most 75, most preferably at most 70, but at least 20.

The softening temperature of the polymer compositions of the invention is preferably at least 40° C., more preferably at least 100° C., most preferably at least 130° C. The softening temperature of the polymer compositions of the invention is preferably not more than 220° C.

The compositions of the invention may be produced in any manner desired and known per se, such as, for instance, by simple mixing of the individual components.

The optional ingredients, such as components (A′) and also (C) to (I), for example, may be added during the mixing operation and/or, subsequently to the completed compositions.

A further subject of the invention is a method for producing the compositions of the invention, wherein

### In a First Step

components (A) and (B) and also, optionally, one or more of the components (A′) and (C) to (I) are placed into a reactor and melted and are mixed by means of a mixing assembly,

### In a Second Step

the mixture obtained in the first step is discharged and allowed to cool, and

### In a Third Step, Carried Out Optionally,

the mixture obtained in the second step is optionally mixed with one or more of the components (A′) and (C) to (I) and is comminuted and/or pelletized.

In the process of the invention, the third step is preferably carried out.

If in the process of the invention the third step is carried out, this may take place after the end of the second step or may be carried out simultaneously with the second step.

The process of the invention may take place in the presence or absence of solvent, with solvent-free production being preferred.

The process of the invention may be carried out continuously, batchwise or semibatchwise, but preferably continuously.

The individual components are added to the reactor in the first step of the process of the invention either separately or in an already premixed form, such as in the form of premixed pellets, for example. This may be done by the prior-art methods such as via metering screws, for example. In the reactor the components are preferably mixed by means of shearing elements such as extruder screws, for example. If desired, the reactants to be mixed may be dried in accordance with the prior art before being processed.

The discharge of the mixed composition of the invention in accordance with the second step of the method of the invention may likewise take place by the mixing assembly itself or additionally by means of a transport unit such as a melt pump, for example.

The weight ratio of component (B) used in the first step of the method of the invention to thermoplastic polyurethane polymer (A) is preferably in the range from 10:90 to 80:20, more preferably 20:80 to 60:40, most preferably 20:80 to 50:50.

With the method of the invention, preferably at least steps 1 to 2 are carried out in continuously operating kneaders or mixers or extruders, and the individual components for mixing in accordance with the invention are supplied continuously to the mixing assembly in the first step, either in pure form or as a premix, gravimetrically or volumetrically in each case. Components which are present in the overall mixture with a proportion of below 1 wt % are preferably supplied as a premix in one of the components with a larger proportion.

The temperatures at which the first step of the method of the invention is carried out depend primarily on the components used and are known to the skilled person, with the proviso that they are below the specific decomposition temperatures of the individual components used. The method of the invention is preferably carried out at temperatures below 250° C., more preferably in the range from 150 to 220° C., most preferably at temperatures of 180 to 210° C.

The first step of the method of the invention is preferably carried out under the pressure of the surrounding atmosphere, in other words at between 900 and 1100 hPa. Higher pressures, however, may also be employed, and are dependent in particular on the mixing assembly used. Hence the pressure in different regions of the kneaders, mixers or extruders used is, for example, significantly greater than 1000 hPa, preferably greater than 10,000 hPa, and most preferably greater than 20,000 hPa.

The composition produced in accordance with the invention is preferably in pellet form or in powder form, but preferably in pellet form. By means of a corresponding pelletizing system, the composition of the invention can also be obtained in the form of micropellets.

After the operation of mixing the individual components in accordance with the first step, the composition of the invention is then discharged from the reactor in the second step, preferably in the form of a hot melt of high viscosity and preferably via a die, and is caused to cool, preferably by means of a cooling medium, to temperatures of between 5° C. and 60° C. In a preferred method here, the material, following its emergence, is cooled by means of a cooling medium and then comminuted or pelletized in a third step. In this case, the cooling of the material and the pelletizing may take place simultaneously by means of underwater pelletizing or in succession. Preferred cooling media used are water or air. Preferred pelletizing methods here are underwater pelletizing, pelletizing by means of air cutting, and strand pelletizing.

The pellets produced in accordance with the invention preferably have a weight of less than 0.5 g, more preferably less than 0.25 g, most preferably less than 0.125 g per pellet. The pellets produced in accordance with the invention preferably have a weight of at least 5 mg per pellet.

The pellets obtained in accordance with the invention are preferably cylindrical or spherical, with a preferred lengthwise extent in the range of from 0.1 to 10 mm, more preferably 1 to 7 mm.

According to one preferred embodiment of the method of the invention, the individual components, preferably in pellet form, in powder form or in the form of fibers, are metered gravimetrically into a multiscrew extruder, where they are melted at temperatures between 180 and 210° C. and mixed, and the mixture is discharged from the mixing assembly by means of a melt pump and by means of underwater pelletizing is cooled, pelletized, and dried.

In the production of the compositions of the invention, it is additionally possible to bring about reaction between any functional groups contained in component (A) and/or component (B), and any functional groups newly formed during the production of the composition of the invention, by hydrolysis or thermal bond breakage, for example. This may take place by methods including the reaction of any carboxylic acid, hydroxide, amine, isocyanate, urethane or urea bonds present or formed, to give amide bonds, esters, urethanes, ureas, allophanates or biuret bonds.

The compositions of the invention are preferably reprocessable. As used herein, “reprocessable” means that the compositions can easily be processed in other conventional shaping operations such as injection molding and blowmolding. The compositions of the invention which are subsequently reprocessed typically display physical properties (e.g., tensile strength, elongation, compressive strain, and hardness) which are similar to the original values.

In one embodiment, the composition of the invention has a hardness as measured in accordance with DIN EN 53505 (Shore A), which is 5 points lower, preferably 10 points lower, more preferably 15 points lower, than that of the pure polyurethane polymer (A) used.

The polymer compositions of the invention, particularly in the form of pellets, can be subjected to further thermoplastic processing in a downstream step by extrusion to form a molding, preferably a profile. In this case, according to a preferred procedure, the compositions of the invention in the form of a pelletized material are conveyed continuously into a kneader or extruder in accordance with the prior art, heated and plasticified in this kneader or extruder by exposure to temperature, and then pressed through a die which dictates the desired profile shape. Here, accordingly, depending on the configuration of the die, either solid profiles or else hollow profiles can be manufactured.

A further subject of the invention are moldings produced by extruding the polymer compositions of the invention.

In one preferred embodiment, the composition of the invention is extruded directly, via an appropriate die, continuously in the form of a profile, which can then—likewise after cooling—be trimmed and/or cut to length.

The polymer compositions obtained are preferably thermoplastic, meaning that the temperature at which the loss factor (G″/G′) in accordance with DIN EN ISO 6721-2:2008 has a value of 1 is preferably at least 40° C., more preferably at least 100° C.

The polymer compositions of the invention can be used anywhere TPUs have also been employed to date.

The compositions of the invention have the advantage that they are easy to produce.

The compositions of the invention have the advantage that they can be processed by conventional technologies such as extrusion, vacuumforming, injection molding, blowmolding or compression molding. Moreover, these compositions can be reprocessed (recycled) with little or no diminution in the mechanical properties.

Furthermore, an advantage of the compositions of the invention is that in spite of the low Shore A hardnesses, the silicone fraction means that they have a significantly lower tendency to stick to one another.

The density of the composition of the invention is preferably lower than the density of component (A), allowing relatively lightweight components to be obtained.

It is advantageous here as well that the polymer compositions of the invention exhibit low water absorption.

The method of the invention has the advantage that the properties of the thermoplastic polymer mixtures can be adjusted in a targeted manner in such a way that, in particular, flexible materials with a Shore A hardness of below 70 are obtained in conjunction with a high tensile strength and elongation at break.

Another advantage of the method of the invention is that it can be employed universally and is very versatile.

Possible uses of the compositions of the present invention include the production of parts and components for automotive, electronics, electrical, communications, household, and medical applications. For example, the compositions can be used to produce wire and cable insulation; for automotive and household appliance components such as belts, hoses, boots, bellows, seals; for components of gasoline lines and air conduits; for architectural seals, bottle closures, furniture components, soft-feel grips for hand-held implements (e.g., grips for tools), medical devices such as catheters, sports articles, for the coating of textiles such as airbags, for example, and for rubber parts in general.

Further possible applications are as sealants, additives for polymer processing, such as processing assistants in extrusion of thermoplastics, antifouling coatings, foils and films, coatings additives, an auxiliary for modifying resins or for modifying bitumen, a plastics additive, such as impact tougheners or flame retardants, as packaging material for electronic components, in insulating or shielding materials, in cable cladding, as coating material for wood, paper, and card, coating material for textile fibers or textile fabrics, coating material for natural substances such as leather and furs, for example, material for membranes or a constituent in sports equipment such as sports footwear, for example. Preferred applications of the polymer mixtures of the invention are uses as a constituent in adhesives and sealants, as a base material for thermoplastic elastomers such as cable claddings, hoses, seals, keyboard mats, for example, for membranes, such as membranes with selective gas-permeability, for coating applications, in nonstick coatings, tissue-compatible coatings, flame-retarded coatings, for example, and as biocompatible materials.

The polymer compositions of the invention surprisingly exhibit outstanding properties in relation to adhesion and low-temperature elasticity in injection molding applications for the electronics and medical sectors, for example, or in extrusion applications for fibers or technical foils and films.

In the examples described below, all of the viscosity data are based on a temperature of 25° C. Unless otherwise indicated, the examples below are carried out under a pressure of the surrounding atmosphere, in other words approximately 1000 hPa, and at room temperature, in other words at approximately 23° C., and/or at a temperature which comes about when the reactants are combined at room temperature without additional heating or cooling, and also at a relative atmospheric humidity of approximately 50%. Furthermore, all figures for parts and percentages are based on the weight, unless otherwise indicated.

Products used in the examples are as follows:

TPU 1: thermoplastic polyurethane (for properties see Table 2) available commercially under the name Elastollan® SP 9264 from BASF SE, Ludwigshafen (DE);

TPU 2: thermoplastic polyurethane (for properties see Table 2) available commercially under the name Desmopan® 9370A from Covestro A G, Leverkusen (DE);

TPU 3: thermoplastic polyurethane (for properties see Table 2) available commercially under the name Desmopan® DP 6064A from Covestro A G, Leverkusen (DE);

Copolymer B1:

In a twin-screw kneader from Collin, Ebersberg (DE), with 6 heating zones, under a nitrogen atmosphäre, a diisocyanate (methylenebis(4-isocyanatocyclohexane)) (H12MDI) (available commercially under the name Desmodur W from Covestro A G, Leverkusen (DE)) was metered into the first heating zone and a bisaminopropyl-terminated polydimethylsiloxane having a molecular weight of 11,832 g/mol was metered into the second heating zone. The temperature profile of the heating zones was programmed as follows: zone 1 30° C., zone 2 140° C., zone 3 170° C., zone 4 190° C., zone 5 195° C., zone 6 185° C. The rotary speed was 150 rpm. The diisocyanate (methylenebis(4-isocyanatocyclo-hexane)) (H12MDI) was metered into zone 1 at 607 mg/min (139 mmol/h), and the amine oil component was metered into zone 2 at 25 g/min (138.5 mmol/h). At the die of the extruder, a colorless, highly transparent polydimethylsiloxane-polyurea block copolymer was obtained, and was subsequently pelletized. The molecular weight was 146,800 g/mol (number average), 308,000 g/mol (weight average). The Shore A hardness was 25, the residual isocyanate content 172 ppm. The elongation at break was 425%. The temperature at which the loss factor (G″/G′) in accordance with ISO 6721-10 has a value of 1 was in this case 185° C. (measuring frequency 1 Hz, deformation 0.1%).

Copolymer B2:

In a twin-screw kneader from Collin, Ebersberg (DE), with 6 heating zones, under a nitrogen atmosphere, a diisocyanate (methylenebis(4-isocyanatocyclohexane)) (H12MDI) (available commercially under the name Desmodur W from Covestro A G, Leverkusen (DE)) was metered into the first heating zone and a bisaminopropyl-terminated polydimethylsiloxane having a molecular weight of 14,690 g/mol was metered into the second heating zone. The temperature profile of the heating zones was programmed as follows: zone 1 30° C., zone 2 140° C., zone 3 170° C., zone 4 190° C., zone 5 195° C., zone 6 185° C. The rotary speed was 150 rpm. The diisocyanate (methylenebis(4-isocyanatocyclo-hexane)) (H12MDI) was metered into zone 1 at 448 mg/min (102.6 mmol/h), and the amine oil component was metered into zone 2 at 25 g/min (102.1 mmol/h). At the die of the extruder, a colorless, highly transparent polydimethylsiloxane-polyurea block copolymer was obtained, and was subsequently pelletized. The molecular weight was 202,400 g/mol (number average), 418,250 g/mol (weight average). The Shore A hardness was 18, the residual isocyanate content 153 ppm. The elongation at break was 525%. The temperature at which the loss factor (G″/G′) in accordance with ISO 6721-10 has a value of 1 was in this case 188° C. (measuring frequency 1 Hz, deformation 0.1%).

### Example 1

1.6 kg of TPU 1 were added with 0.40 kg of copolymer B1, each in pellet form, continuously via a hopper, into zone 1 of a counter rotating twin-screw extruder ZK 25 from Collin (Ebersberg (DE)) and compounded. The temperature here was 100° C. in the intake region (zone 1) and was raised to 160° C. in zone 2 and to 165° C. in zone 3. Zone 4 and zone 5 were at 170° C., and the die was heated at 165° C. The rotary speed of the screws was 60 revolutions/minute. The homogeneous melt obtained was extruded as a strand, cooled to 30° C. in a water bath, and then pelletized by means of a strand pelletizer. This gave 1.85 kg of polymer blend with a copolymer B1 content of 20 wt %.

### Examples 2-6

The procedure described in Example 1 is repeated with the modification that the features set out in Table 1 were selected.

TABLE 1

| | Example | | | | | |
|---|---|---|---|---|---|---|
| | 1 | 2 | 3 | 4 | 5 | 6 |
| TPU 1 [kg] | 1.6 | 1.2 | | | | |
| TPU 2 [kg] | | | 1.6 | 1.2 | | |
| TPU 3 [kg] | | | | | 1.6 | 1.2 |
| Copolymer B1 | 0.4 | 0.8 | 0.4 | 0.8 | | |
| [kg] | | | | | | |
| Copolymer B2 | | | | | 0.4 | 0.8 |
| [kg] | | | | | | |
| Heating zone 1 | 100 | 100 | 100 | 100 | 100 | 100 |
| [° C.] | | | | | | |
| Heating zone 2 | 160 | 160 | 170 | 170 | 170 | 170 |
| [° C.] | | | | | | |
| Heating zone 3 | 165 | 165 | 180 | 180 | 180 | 180 |
| [° C.] | | | | | | |
| Heating zone 4 | 170 | 170 | 185 | 185 | 180 | 180 |
| [° C.] | | | | | | |
| Heating zone 5 | 170 | 170 | 185 | 185 | 175 | 175 |
| [° C.] | | | | | | |
| Heating zone 6 | 165 | 165 | 180 | 180 | 170 | 170 |
| [° C.] | | | | | | |
| Rotary speed | 60 | 60 | 60 | 60 | 60 | 60 |
| [revolution/ | | | | | | |
| min] | | | | | | |
| Amount | 1.85 | 1.90 | 1.80 | 1.85 | 1.90 | 1.95 |
| obtained | | | | | | |
| [kg] | | | | | | |

TABLE 2
Determination of the mechanical properties

| | Tensile | Elongation | | | | Strain at | |
|---|---|---|---|---|---|---|---|
| | strength | at break | | TR | Density | 100% | |
| Example | [MPa] | [%] | Shore A | [N/mm] | [g/cm³] | elongation | Color |
| 1 | 7.8 | 938 | 64 | 51.1 | 1.16 | 2.2 MPa | white |
| 2 | 5.4 | 898 | 56 | 37.2 | 1.12 | 1.7 MPa | white |
| 3 | 12.0 | 930 | 64 | 64.1 | 1.05 | 2.3 MPa | white |
| 4 | 7.7 | 839 | 53 | 37.8 | 1.04 | 1.6 MPa | white |
| 5 | 6.2 | 965 | 58 | 46.2 | 1.07 | 2.0 MPa | white |
| 6 | 5.1 | 728 | 53 | 39 | 1.05 | 1.6 MPa | white |
| TPU 1 | 20 | 960 | 67 | n.d. | 1.2 | n.d. | translucent |
| TPU 2 | 25 | 730 | 70 | n.d. | 1.06 | n.d. | translucent |
| TPU 3 | 18 | 1060 | 65 | n.d. | 1.09 | n.d. | translucent |
| Copolymer | 1.2 | 425% | 25 | n.d. | 1.00 | n.d. | transparent |
| B1 | | | | | | | |
| Copolymer | 0.5 | 525 | 18 | n.d. | 1.00 | n.d. | transparent |
| B2 | | | | | | | |

The mechanical properties were determined on injection molded test specimens after storage of the test for 1 week.

The Shore A hardness is determined according to DIN EN 53505. The tensile strength is determined according to DIN EN 53504-S1.

The elongation at break is determined according to DIN EN 53504-S1.

The 100% modulus is determined according to DIN EN 53504-S1. The tear resistance is determined according to ASTM D 624 B.

1.-10. (canceled)

11. A polymer composition, comprising:
(A) at least one polyurethane polymer and
(B) at least one siloxane-organic copolymer having 100 to 3000 siloxane units per siloxane segment and at least one organic segment having at least one group selected from ester groups, amide groups, urethane groups, urea groups, and thiourea groups, wherein (B) comprises siloxane-organic copolymers of the formula (1) 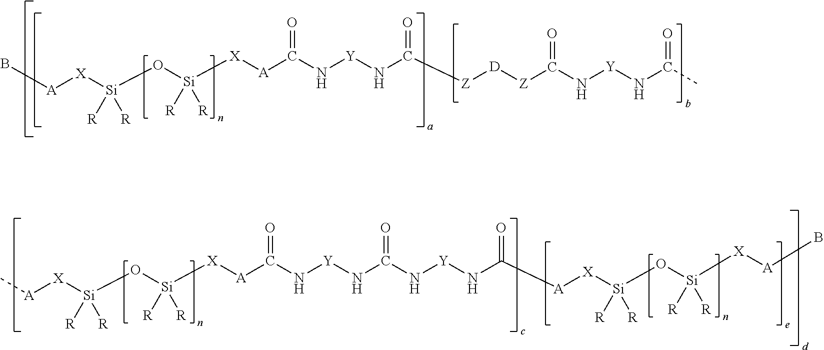
where
R are identical or different and are monovalent, SiC-bonded hydrocarbyl radicals having 1 to 20 carbon atoms optionally substituted by fluorine or chlorine,
X are identical or different alkylene radicals which have 1 to 20 carbon atoms and in which nonadjacent methylene units are optionally replaced by —O— groups,
A are identical or different and are oxygen, sulfur, or an amino group —NR′—,
Z are identical or different and are oxygen or an amino group —NR′—,
R′ are identical or different and are hydrogen or an alkyl radical having 1 to 10 carbon atoms,
Y are identical or different and are divalent hydrocarbyl radical which have 1 to 20 carbon atoms and are optionally substituted by fluorine or chlorine,
D are identical or different and are divalent hydrocarbyl radicals which are optionally substituted by fluorine, chlorine or C₁-C₆ alkyl ester groups and in which nonadjacent methylene units are optionally replaced by —O—, —COO—, —OCO— or —OCOO— groups,
B are identical or different and are hydrogen or a functional or nonfunctional organic or silicon-organic radical,
n are identical or different and are a number from 99 to 2999,
a is a number which is at least 1,
b is 0 or a number from 1 to 100,
c is 0 or a number from 1 to 100,
d is a number which is at least 1, and
e is a number which is 0 or 1.

12. The polymer composition of claim 11, wherein the amount of siloxane units in component (B) is between 80 and 99.5 wt %.

13. The polymer composition of claim 11, wherein polyurethane polymers (A) are thermoplastic.

14. The polymer composition of claim 12, wherein polyurethane polymers (A) are thermoplastic.

15. The polymer composition of claim 11, wherein polyurethane polymers (A) have a softening range at 1000 hPa at 90 to 220° C.

16. The polymer composition of claim 12, wherein polyurethane polymers (A) have a softening range at 1000 hPa at 90 to 220° C.

17. The polymer composition of claim 11, wherein the weight ratio of the siloxane-organic copolymer (B) to the polyurethane polymer (A) is in the range from 10:90 to 80:20.

18. The polymer composition of claim 12, wherein the weight ratio of the siloxane-organic copolymer (B) to the polyurethane polymer (A) is in the range from 10:90 to 80:20.

19. The polymer composition of claim 14, wherein the weight ratio of the siloxane-organic copolymer (B) to the polyurethane polymer (A) is in the range from 10:90 to 80:20.

20. A method for producing a composition of claim 11, comprising:
in a first step
introducing components (A) and (B) and also, optionally, one or more of the components (A′) and (C) to (I) into a reactor, melting, and mixing by means of a mixing assembly,
in a second step
discharging the mixture obtained in the first step is discharged and cooling the mixture, and
optionally in a third step
mixing the mixture obtained in the second step with one or more further components and comminuting and/or pelletizing.

21. The method of claim 19, wherein the third step is carried out.

22. The method of claim 19, wherein the method is carried out continuously.

23. A molding produced by extruding a polymer composition of claim 11.
